(19) United States
(12) Patent Application Publication
(10) Pub. No.: US 2011/0145855 A1
(43) Pub. Date: Jun. 16, 2011

(54) CONTENT PROCESSING APPARATUS, REPRODUCING APPARATUS, CONTENT PROCESSING SYSTEM AND RECORDING MEDIUM

(76) Inventors: Eiji Muramatsu, Saitama (JP); Kazuo Kuroda, Saitama (JP); Takao Sawabe, Saitama (JP); Akira Imamura, Saitama (JP); Toshio Suzuki, Saitama (JP); Masahiro Kato, Saitama (JP); Shoji Taniguchi, Saitama (JP)

(21) Appl. No.: 12/513,759

(22) PCT Filed: Nov. 7, 2006
(86) PCT No.: PCT/JP2006/322158

§ 371 Date: May 26, 2009

(51) Int. Cl. H04N 7/10

(52) U.S. Cl. 725/32

(57) ABSTRACT

Provided herein is a disc player having a read-out unit, a network connector, and a controller. The read-out unit reads out from an optical disc recorded with a main content and CM insertion information as information on an insertion of a Advertisement in the main content thereon. The network connector acquires the advertisement from an external apparatus based on CM insertion information. The controller controls to insert the acquired Advertisement in the main content.

### TECHNICAL FIELD

The present invention relates to a content processing apparatus which performs edit and the like of a content including at least either one of video or audio, a reproducing apparatus, a content processing system and a recording medium.

### BACKGROUND ART

In recent years, there is known a method in which an expiration date is set in a part of a content recorded on a recording medium and a part of information of the content can not he reproduced after the expiration date passes (for example, Patent Document 1). According to the method, even if an advertisement is included in the recording medium, it is possible to avoid that the advertisement becomes obsolete by setting the expiration date on the advertisement.

### [Patent Document 1] JP-A-10-307741

### DISCLOSURE OF THE INVENTION

### Problems to be Solved

However, in the above method, after the expiration date passes, it is not possible to reproduce the advertisement set with the expiration date. Originally, a purpose for recording an advertisement on a recording medium is to suppress a retail price of the recording medium by applying an advertising fee to fabrication cost of the recording medium (a content). In the case that the expiration date is set as the above method, effect thereof becomes reduced. In other words, in spite that the expiration date is set so as not to lower value thereof as advertising medium (so as to avoid that the advertisement becomes obsolete), an advertising term is necessarily shortened. This does not lead to effective advertising income, resulting in reducing a price curb effect of the recording medium.

Hereafter, with high capacity of an optical disc medium, in a case that a plurality of, for example, more than hundreds of contents each of which can be viewed independently are stored on a single optical disc, it is considered that necessity for advertising income for retail price curb of a recording medium will increase. With such an optical disc medium having high capacity, a viewing style is imaginable, by which a user arbitrarily selects a desired content among hundreds of titles when the user desires. In such a case, it is desirable that a system be capable of effectively reproducing an advertisement according to a content that the user selected or time.

It is an advantage of the invention to provide a content processing apparatus which utilizes a recording medium effectively as advertising medium and a source of advertising income, a reproducing apparatus, a content processing system and a recording medium.

### Means to Solve the Problems

According to one aspect of the invention, there is provided a content processing apparatus having a read-out unit which reads out from a recording medium in which a main content and CM insertion information showing an insertion position of an advertisement in the main content as a flag is stored, an advertisement acquiring unit which acquires the advertisement from an external apparatus based on the CM insertion information and an advertisement insertion unit which inserts the acquired advertisement in the main content, the advertisement acquiring unit acquiring the advertisement with detection of the flag at a time of reproducing the main content.

With this configuration, the advertisement never becomes obsolete because the advertisement is acquired from the external apparatus and is inserted in the main content. Accordingly, it is possible to provide new advertising information at all times from the external apparatus to viewers (users) and to maintain value thereof as advertising medium. Further, as the value is permanent, it is possible to utilize the recording medium as effective advertising income source. Still further, as the advertisement is acquired at the time of reproducing the main content, it is not necessary to pre-acquire the advertisement to insert it in the main content. In other words, as the advertisement is acquired when a user actually views, it is possible to acquire the advertisement which is adapted to the date or circumstances. Still further, as an advertising provider (CM sponsor) can provide a timely CM via the external apparatus, it is possible to enhance value as advertising medium of the recording medium. Moreover, as the advertisement is acquired with the detection of the flag, it is possible to pre-define the insertion position of the advertisement. Accordingly, it is possible to insert the advertisement at a reproduction position where the advertising provider desires such as before the main content by a setting position of the flag.

Timing for acquiring the advertisement may be arbitrary timing such as at reading out of the recording medium, at acquiring instruction for the advertisement by a user or the like.

According to one aspect of the invention, there is provided a reproducing apparatus having a read-out unit which reads out from a recording medium in which a main content and CM insertion information showing an insertion position of an advertisement in the main content as a flag is stored, an advertisement acquiring unit which acquires the advertisement from an external apparatus based on the CM insertion information, an advertisement insertion unit which inserts the acquired advertisement in the main content, and a reproducing unit which reproduces the main content inserted with the advertisement. The advertisement acquiring unit acquires the advertisement with detection of the flag at a time of reproducing the main content.

With this configuration, as the advertisement is acquired at the time of reproducing the main content, it is not necessary to pre-acquire the advertisement to insert it in the main content. In other words, as the advertisement is acquired when a user actually views, it is possible to acquire the advertisement which is adapted to the date or circumstance. Further, as an advertising provider (CM sponsor) can provide a timely CM via the external apparatus, it is possible to enhance value as advertising medium of the recording medium. Still further, as the advertisement is acquired with the detection of the flag, it is possible to pre-define the insertion position of the advertisement. Accordingly, it is possible to insert the advertisement at a reproduction position where the advertising provider desires such as before the main content by a setting position of the flag.

According to another aspect of the invention, there is provided a reproducing apparatus having a read-out unit which reads out from a recording medium in which a main content and CM insertion information showing an insertion position of an advertisement in the main content as a table is stored, an advertisement acquiring unit which acquires the advertisement from an external apparatus based on the CM insertion information, an advertisement insertion unit which inserts the acquired advertisement in the main content, and a reproducing unit which reproduces the main content inserted with the advertisement. The advertisement acquiring unit acquires the advertisement by referring to the CM insertion information at a time of reproducing the main content and the reproducing unit reproduces the advertisement at timing based on the insertion position of the advertisement.

With this configuration, as the advertisement is reproduced at timing based on a reference result of the table (CM insertion information), it is possible to pre-define the insertion position of the advertisement. In other words, by setting the table, it is possible to insert the advertisement at the reproducing position such as before the main content where the advertising provider desires. The timing of acquiring the advertisement may be timing based on the insertion position (reproduction time based on the insertion position) or timing after referring to the table and before arbitrary insertion timing.

In the above described reproducing apparatus, it is preferable that the CM insertion information include an ID for specifying the advertisement, and the advertisement acquiring unit acquire the advertisement specified by the external apparatus by sending the ID to the external apparatus.

With this configuration, it is possible to reproduce various Advertisements by, for example, associating a different ID per insertion position. Accordingly, it is possible to obtain advertising income from a plurality of advertising providers and to not get users bored by repeating a same CM. Further, by associating a different ID per recording medium, the advertisement can not be viewed unless the recording medium is acquired, leading to enhance value of the advertisement.

In the above described reproducing apparatus, it is preferable that the reproducing unit perform a fade-in/fade-out process on the main content before and after the insertion position of the advertisement.

With this configuration, as switching of the main content and the advertisement can be done smoothly, it is possible to provide CM to viewers more naturally. The “fade-in/fade-out process” is directed to change to louder/softer of volume in audio and video effect such as black-out/white-out in video.

In the above described reproducing apparatus, it is preferable that the recording medium be recorded with one or more main contents, each of the main contents be associated with insertion availability information regarding whether the advertisement is inserted or not. It is also preferable that the advertisement acquiring unit acquire the advertisement at the time of reproducing the main content associated with “available” of the insertion availability information.

With this configuration, it is possible to determine whether the advertisement is reproduced or not per main content by the insertion availability information. Accordingly, the advertisement is not inserted in an ancillary content such as, for example, a bonus content, resulting in user's merit.

In the above described reproducing apparatus, it is preferable that the apparatus further have a content key acquiring unit which acquires a content key for prohibiting an insertion of the advertisement in the main content, and an insertion availability information rewriting unit which rewrites the insertion availability information of a corresponding main content from “available” to “not-available” with acquisition of the content key.

With this configuration, as the insertion of the advertisement is prohibited with the acquisition of the content key, viewers who do not want to view can get a merit, and a recording medium (content) provider can get profit by charging for the content key.

In the above described reproducing apparatus, it is preferable that each of the main contents be associated with address information showing an acquisition source for the advertisement, and the advertisement acquiring unit acquire the advertisement by accessing based on the address information associated with each of the main contents.

With this configuration, it is possible to reproduce a different content per main content by associating each of the main contents with a different address information. Accordingly, it is capable of contracting with a sponsor per main content.

According to another aspect of the invention, a content processing system has the content processing apparatus, the recording medium and the external apparatus described above.

With this configuration, it is possible to provide the content processing system which utilizes the recording medium effectively as advertising medium and advertising income source.

In the above described content processing system, it is preferable that the CM insertion information include information for specifying the main content and information showing an insertion position of the advertisement, and the advertisement acquiring unit acquire the advertisement specified by the external apparatus by sending at least one of the information for specifying the main content and the information showing the insertion position of the advertisement to the external apparatus. It is also preferable that the external apparatus have a Advertisement storing unit which stores a plurality of Advertisements, an information acquiring unit which acquires at least one of the information for specifying the main content and the information showing the insertion position of the advertisement from the content processing apparatus, a Advertisement specifying unit which specifies the advertisement to be an insertion object from the advertisement storing unit based on the acquired information by the information acquiring unit, and a Advertisement sending unit which sends the specified Advertisement to the content processing apparatus.

With this configuration, it is possible to provide the CM of which advertising effect is higher by sending the information for specifying the main content and the information showing the insertion position of the advertisement to the external apparatus and acquiring the specified Advertisement based on these pieces of information by the content processing apparatus. For example, in a case that the information for specifying the main content is sent to the external apparatus, the external apparatus can specify the advertisement to be sent based on a content of the main content. Accordingly, in a case that the main content is for men for example, it is possible to provide the CM of which object for advertisement is oriented to men. Also, it is possible to provide CM linked to the content of the main content by sending the information showing the insertion position of the advertisement, together with the information for specifying the main content.

According to another aspect of the invention, there is provided a recording medium to be recorded with contents. The recording medium stores a plurality of pre-recorded main contents which are viewable independently and CM insertion information which is information for inserting an advertisement acquired from an external apparatus other than a reproducing apparatus of the recording medium and which shows an insertion position of the advertisement with a flag in the main content. The advertisement is acquired by the reproducing apparatus with detection of the flag at a time of reproducing the main content.

With the configuration, it is possible to provide the recording medium capable of being utilized effectively as advertising medium and advertising income source. It is conceivable that recording media stored with a plenty of main contents will be used in common and necessity for advertising income for restraining retail prices thereof in the future will increase. According to the configuration, it is especially useful even under such circumstances.

### BRIEF DESCRIPTION OF THE DRAWINGS

FIG. 1 is a system configuration diagram of a content processing system according to a first embodiment of the invention.

FIG. 2 is a control block diagram of a disc player.

FIG. 3 is a diagram which explains CM insertion information.

FIG. 4 is a diagram which explains download information.

FIG. 5 is a flow chart which shows CM insertion/reproduction process of the disc player.

FIG. 6 is a diagram which explains another example of CM insertion information.

FIG. 7 is a diagram which explains the other example of CM insertion information.

FIG. 8 is a diagram which explains CM insertion information according to a second embodiment.

FIG. 9 is a flow chart which shows CM insertion/reproduction process of the disc player according to a second embodiment.

### REFERENCE NUMERALS

11 disc player
21 content provider
31 network
51 read-out unit
52 write-in unit
53 network connector
54 operation unit
55 controller
56 reproducing processor
57 audio output unit
58 video output unit
D optical disc
SY content processing system

### BEST MODES FOR CARRYING OUT THE INVENTION

A content processing apparatus, a reproducing apparatus, a content processing system and a recording medium according to a preferred embodiment of the invention will now be explained in detail with reference to the accompanying drawings. The invention allows inserting a Advertisement acquired from an external apparatus in a main content read out from a recording medium. An example will be explained in which the recording medium of the invention is adapted to an optical disc, the content processing apparatus and the reproducing apparatus of the invention are adapted to a disc player, and the external apparatus of the invention is adapted to a content provider.

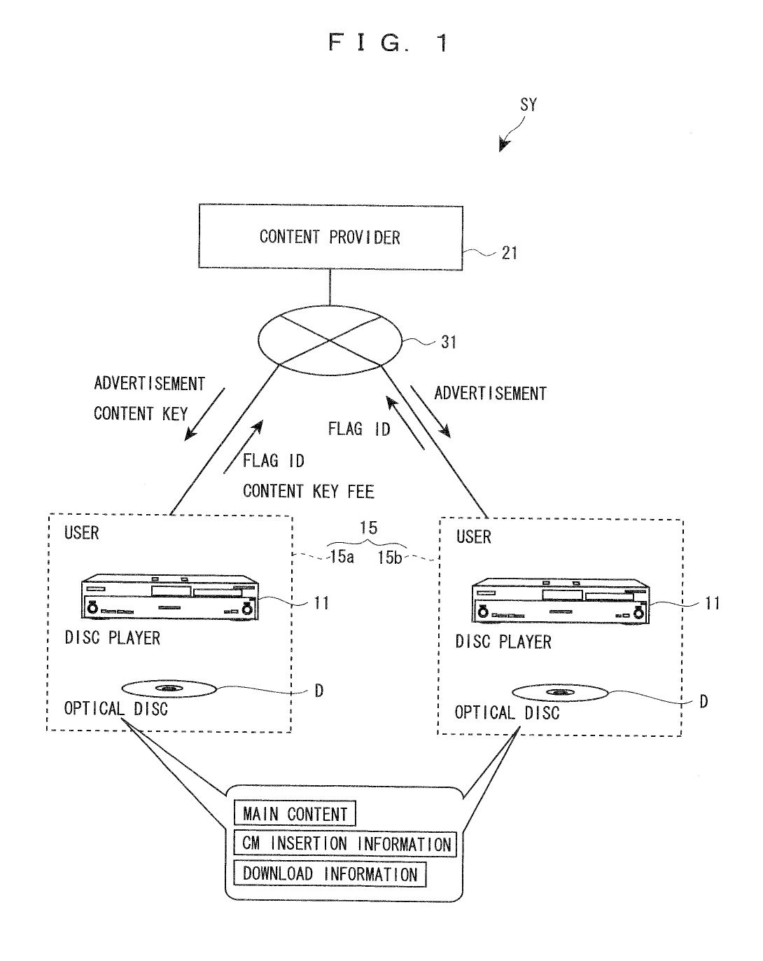

FIG. 1 is a system configuration of a content processing system SY according to a first embodiment of the invention. As shown in FIG. 1, the content processing system SY includes a plurality of disc players 11 (only two are shown), optical discs D which can be read out by each of the disc players 11, and a content provider 21 which provides a Advertisement to a plurality of disc players 11 via a network 31 such as Internet.

In each of the optical discs D, main contents such as a movie, a drama, a video clip and the like as video/audio data, CM insertion information as information on insertion position or the like of the advertisement, and download information as information on availability or the like of the advertisement defined per main content is pre-recorded. Accordingly, optical discs D are sold in a state having all of these pieces of information recorded.

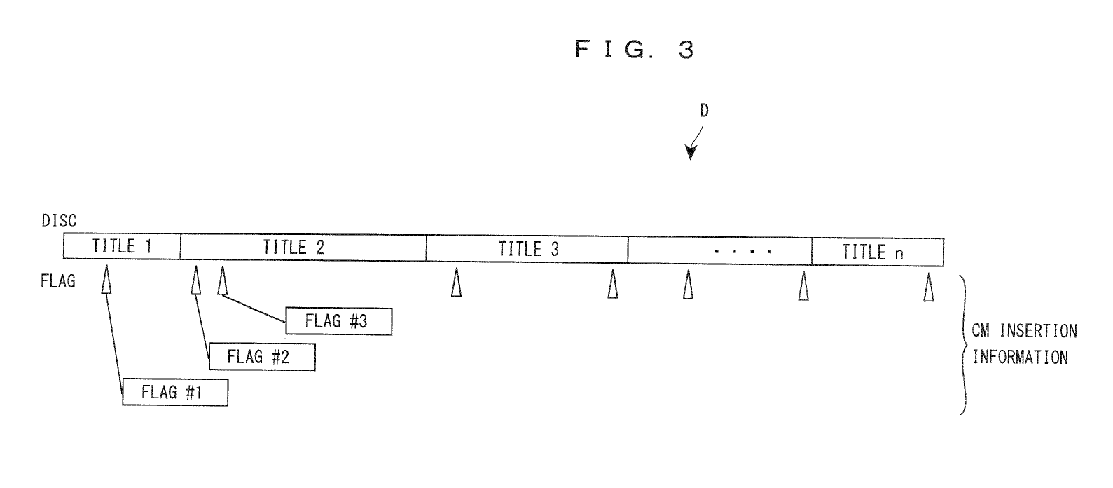

A single optical disc D is recorded with one or more main contents (see TITLE 1-TITLE n in FIG. 3). Further, the CM insertion information includes pieces of information on the insertion position of the advertisement and an ID for specifying the advertisement. In the optical disc D of the preferred embodiment, the insertion positions of Advertisements are shown with flags recorded on the main contents (see FIG. 3). Hereinafter, the ID for specifying the advertisement is refereed as a flag ID. The disc player 11 transmits the flag ID to the content provider 21 and the content provider 21 acquires the advertisement specified based on the flag ID.

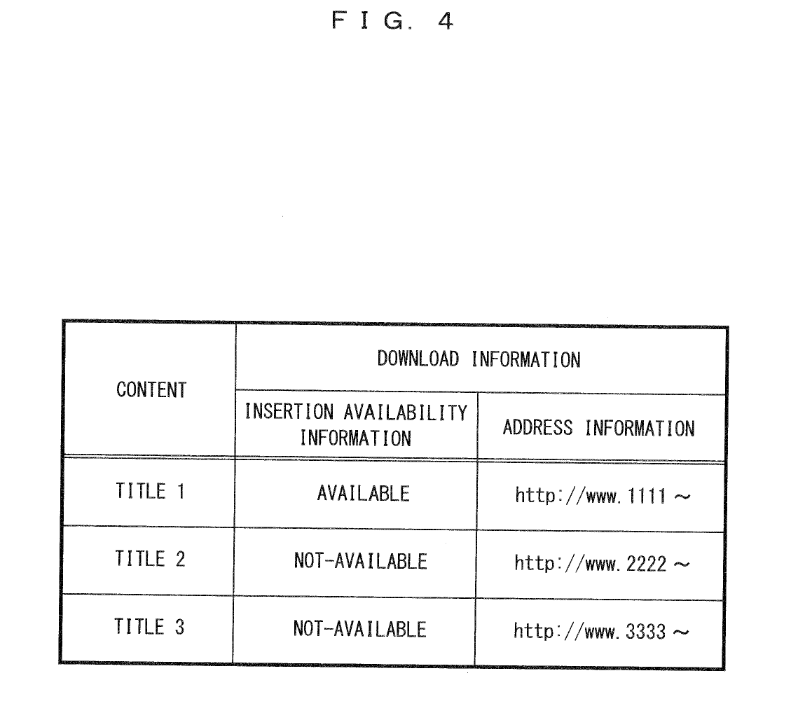

The download information includes pieces of information on insertion availability information regarding whether the advertisement is inserted or not and address information showing an acquisition source of the advertisement (see FIG. 4). In other words, the advertisement is inserted at a flag position recorded on the main content having “available” of the insertion availability information, but the advertisement is not inserted at a flag position recorded on the main content having “not-available” of the insertion availability information (a process for acquiring a Advertisement is not performed). Meanwhile, as the address information is associated with each main content (title), the advertisement is acquired by accessing a same address during reproducing a main content

The insertion availability information is rewritable from the insertion availability information “available” to the insertion availability information “not-available” by acquiring a content key. For example, in a case that the insertion availability information of the “TITLE 1” is recorded as “available”, and when a user 15a acquires the content key of the “TITLE 1” from the content provider 21, it is possible to rewrite the insertion availability information of the “TITLE 1” as “not-available”. Thus, by rewriting the insertion availability information to “not-available”, the user 15 can get a merit to reproduce only the main content. In return for it, the user 15a is obliged to pay a content key fee to the content provider 21. In other words, by charging for providing the content key, a provider of optical discs D (contents) can turn a profit. As for a user 15b who does not pay the content key fee, the advertisement is provided based on the insertion availability information pre-recorded on the optical disc D. A payment for the content key fee may be made without via the network 31.

As shown above, the content processing system SY can be used as each user 15 acquires (purchases) the optical disc D recorded with the above CM insertion information and the like thereon. Thus, by providing the optical disc D on which the CM insertion information is recorded, an advertising fee thereof can be adapted to the fabrication cost for the optical disc D (contents). Therefore, it is possible to suppress the retail prices of the optical discs D, leading to have a merit for users.

It is preferable to configure such that viewing of a main content be prohibited in a case that a Advertisement can not be acquired for some reasons from the content provider 21, so as to surely provide a CM to the users 15. For example, when a rewritable optical disc D is used, a CM acquiring confirmation flag recorded on a predetermined area of the optical disc D may be switched to “ON” with detection of the flag showing the CM insertion position, and the CM acquiring confirmation flag may be switched to “OFF” with acquiring CM from the content provider 21. In this case, when the CM acquiring confirmation flag is “ON”, viewing the main content is prohibited by preventing the main content from being reproduced. In a case that a non-rewritable optical disc D is used, the CM acquiring confirmation flag may be recorded in a RAM (not shown) or the like in the disc player 11.

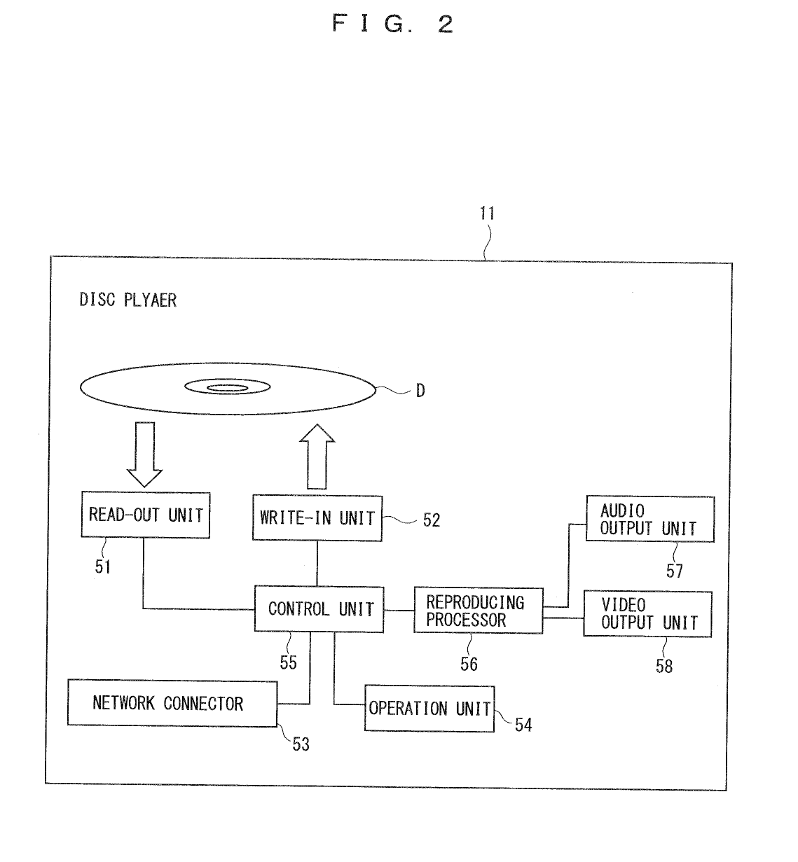

A control configuration of the disc player 11 will be explained with reference to FIG. 2. The disc player 11 has: a read-out unit 51, a write-in unit 52, a network connector 53, an operation unit 54, a controller 55, a reproducing processor 56, an audio output unit 57 and a video output unit 58 as control configuration.

The read-out unit 51 and the write-in unit 52 allow to read out from and write in to the optical disc D, and include such as optical pickups, spindle motors, tracking motors, and drivers (drive control system) therefor. The read-out unit 51 reads out a main content, CM insertion information and download information from the optical disc D, and outputs read-out signals thereof to the controller 55 (read-out means). In the case that the rewritable optical disc D is used, the write-in unit 52 performs rewriting of the insertion availability information based on an instruction from the controller 54 (insertion availability information rewriting means). In the case that the non-rewritable optical disc D is used, the read-out insertion availability information is stored in the RAM (not shown) or the like in the disc player 11, and the controller 54 performs rewriting.

The network connector 53 is an interface which communicates with the content provider 21. The network connector 53 sends the flag ID to the content provider 21 and acquires the advertisement and the content key from the content provider 21 (Advertisement acquiring means, content key acquiring means).

The operation unit 54 allows the user to perform various operations and includes a remote controller, operation buttons and the like. In the preferred embodiment, the operation unit 54 is used for selecting the main content to be reproduced, instructing reproduction, and instructing acquisition of the content key used to rewrite the insertion availability information.

The controller 55 allows to control the disc player 11 overall, and performs read/write controls such as seek control and output power control to the read-out unit 51 and the write-in unit 52. The controller 55 is also used to output the flag ID to the network connector 53 based on the CM insertion information and the download information read out from the optical disc D. When the advertisement is acquired from the network connector 53, the controller 55 performs insertion control of the advertisement such that the advertisement is inserted in the main content (Advertisement insertion means). Video/audio data after inserting the advertisement is stored in an output buffer (not shown), and then, is output to the reproducing processor 56. Also, when acquiring of the content key is instructed by an operation with the operation unit 54, the insertion availability information of a corresponding title is rewritten.

The reproducing processor 56 allows to perform reproducing processes including encoding/decoding process and a digital signal process on input video/audio signals (reproducing means) based on the instruction of the controller 55, and includes an audio/video converter, an encoder, a decoder and the like. When the reproducing process is performed, the reproducing processor 56 performs a fade-in/fade-out process on the main content before and after the insertion position of the advertisement. More specifically, video of the main content is progressively darkened before the insertion position of the advertisement and is made gradually brighter after the insertion position of the advertisement (to return to normal brightness). Accordingly, as the main content and the advertisement can be switched smoothly, the CM can be provided to users 15 naturally. As the “fade-in/fade-out process”, a video effect such as white-out may be used other than the above black-out, and audio (volume) may be changed to be louder/softer.

The audio output unit 57 allows to output audio signals to a speaker (not shown), and is constituted with an audio output terminal. The video output unit 58 allows to output video signals to a monitor (not shown), and is constituted with a video output terminal.

CM insertion information will be explained with reference to FIG. 3, The CM insertion information, as described above, is pre-recorded on the optical disc D, and includes flags showing insertion positions of Advertisements and a flag ID associated with each flag. Flags are recorded on the main contents and are detected when the main content is reproduced. FIG. 3 shows that a flag of a flag ID “#1” is detected when the “TITLE 1” is reproduced, flags of a flag ID “#2” and a flag ID “#3” are detected when the “TITLE 2” is reproduced, and that content insertion/reproduction process is performed based on the detection of these flags. Thus, by associating a different ID with each flag, the advertisement different from one another can be reproduced per insertion position, thereby advertising income can be acquired from a plurality of advertising providers and users 15 do not get bored without repeating a same CM.

The download information will be explained with reference to FIG. 4. The download information is recorded as a table form per main content (title), and includes the insertion availability information regarding whether the advertisement is inserted or not and address information showing an acquisition source of the advertisement. The download information is pre-recorded on the optical disc D as well as the above described CM insertion information. The download information may be recorded on a predetermined area (such as a read-in area) of the optical disc D for a plurality of titles as a table form as a whole, or may be recorded as content information per main content. Thus, by associating the insertion availability information per main content, the advertisement is not inserted in, for example, an ancillary content such as a bonus content, leading to a merit for users. Also, by associating different address information per main content, a different Advertisement per main content can be reproduced, which allows to contract with a sponsor per main content.

An operation of the disc player 11 will be briefly explained when the CM insertion, information and the download information is recorded as shown in FIGS. 3 and 4. As shown in FIGS. 3 and 4, the insertion availability information of the “TITLE 1” is “available”, thereby flag detection is performed when the “TITLE 1” is reproduced, an address “http://www.1111˜” is accessed, and the flag ID “#1” is sent to the content provider 21. The content provider 21 specifies the advertisement to be provided based on the address “http://www.1111˜” and the flag ID “#1”, and sends the specified Advertisement, to the disc player 11. As the disc player 11 acquires the advertisement, it inserts the advertisement at a flag position of the flag ID “#1”. On the other hand, during reproducing the “TITLE 2” and the “TITLE 3”, as the insertion availability information thereof is “not-available”, the flag detection is not performed. Therefore, the advertisement is not inserted in the “TITLE 2” and the “TITLE 3”.

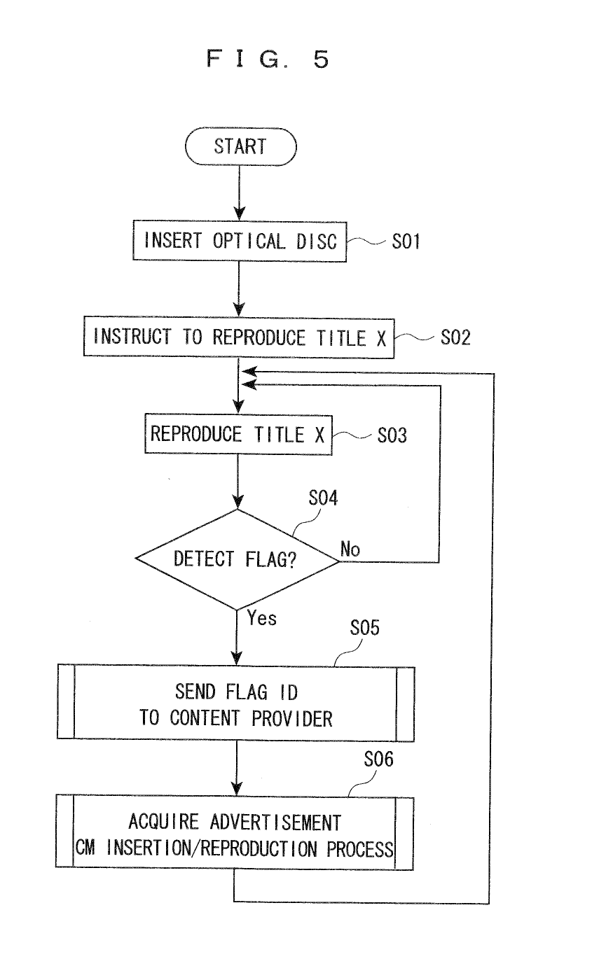

The insertion/reproduction process by the disc player 11 (mainly by the controller 55, see FIG. 2) of the advertisement will be explained with reference to a flow chart of FIG. 5. Note that the explanation is made in a state that the insertion availability information of a title (TITLE X) as reproduced object is “available”.

When the optical disc D is inserted (set) into the disc player 11 (S01) and is instructed to reproduce the title X through the operation unit 54 (S02), the reproducing processor 56 reproduces the title X based on the instruction (S03). As the flag is detected during reproducing the title X (S04: Yes), the controller 55 sends the flag ID associated with the flag to the content provider 21 (S05). Then, when a Advertisement is acquired from the content provider 21, the controller 55 inserts the advertisement at the flag position of the title X and instructs to reproduce to the reproducing processor 56 (S06). At this time, the reproducing processor 56 performs the fade-in/fade-out process on the main content before and after the insertion position of the advertisement. Though not especially shown in the flow chart, a return of the flow chart is ended when the TITLE X is reproduced to the end.

Thus, according to the first preferred embodiment of the invention, as the disc player 11 acquires the advertisement from the content provider 21 and inserts the advertisement in the main content instead of storing the advertisement in the optical disc D, the advertisement will never be obsolete. Further, as the disc player 11 is so constructed to acquire the advertisement during reproducing the main content, a timely CM corresponding to reproduction date and circumstances can be provided to the users 15. Still further, as the disc player 11 is so constructed to acquire the advertisement with the detection of the flag, it is possible to predefine the insertion position of the advertisement. In other words, it is possible to insert the advertisement in the main content at desired timing of an advertising provider such as before the main content.

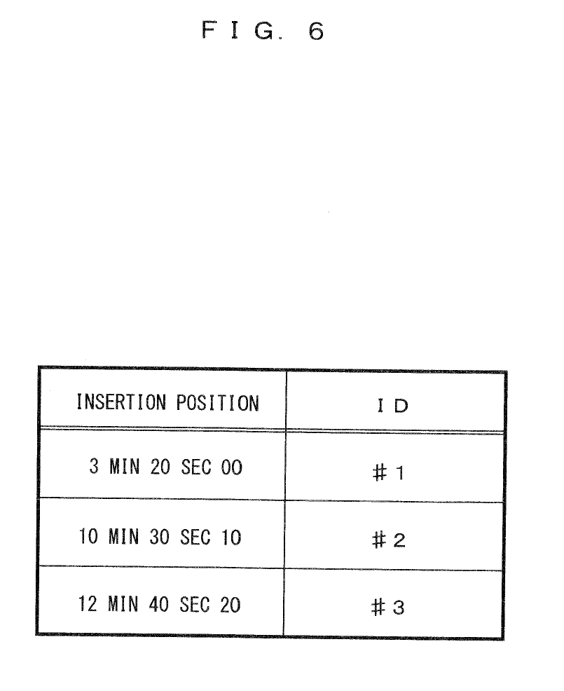

In the above embodiment, the insertion position of the advertisement is defined based on the flag recorded on the main content, but it may be also possible to show the insertion position of the advertisement as a table form as shown in FIG. 6. More specifically, it may be possible to constitute the CM insertion information as a table in which the insertion position is correlated with the ID for specifying the advertisement per record. In the example of FIG. 6, the insertion positions are shown by relative times based on reproduction time. In this case, during reproducing the main content, the table in FIG. 6 is referred to and the advertisement is acquired. The acquired timing may be timing based on the insertion position (reproduction time based on the insertion position) or timing after referring to the table and before arbitrary insertion timing. By pre-acquiring the advertisement at the timing before the insertion timing, processes such as fade-in/fade-out can be done before reproducing the CM and it is possible to prepare for insertion. Also, in the table, as the ID is associated for specifying the advertisement, it is possible to acquire a different Advertisement per insertion position by sending the ID to the content provider 21 as well as the above embodiment. Thus, by showing the insertion position of the advertisement as a table form, generating and embedding of CM insertion information can be easily done in such a case that a single main content has many insertion positions.

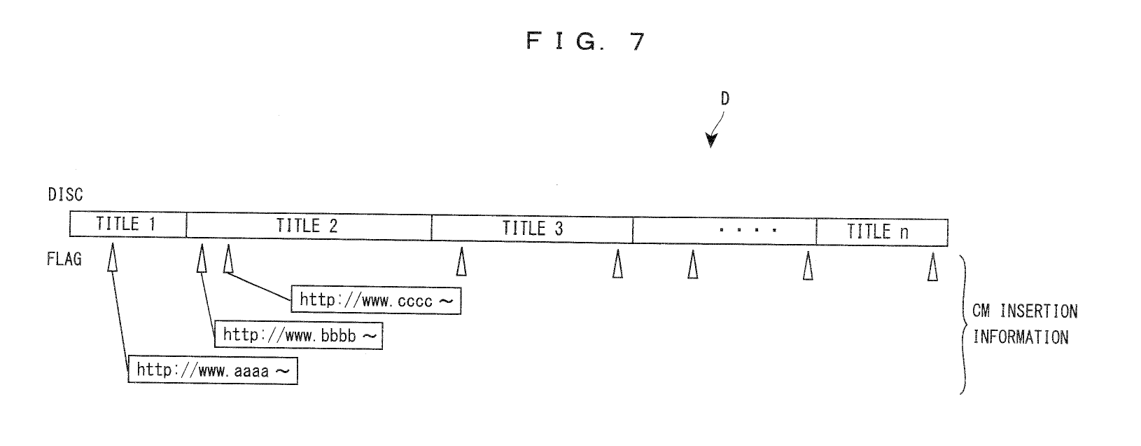

Further, in the above embodiment, the flags recorded on the main contents are associated with respective flag IDs (see FIG. 3). It may be also possible to associate each flag with address information showing an acquisition source of the advertisement as shown in FIG. 7. In this case, when the flag is detected during reproducing the main content, an address of the associated address information is accessed and the advertisement is acquired. According to this configuration, various CMs can be reproduced by associating different address information per flag. In the case that the address information is associated per flag, it is preferable that the address information be not included in the download, information. Note that in a case that the address information is included in the download information, it is necessary to predetermine which information should have priority, the address information included in the download information or the address information associated with each flag.

Further, in the above embodiment, a different ID (flag ID) is associated per flag (per insertion position), but it may be possible to associate a different ID with the optical disc D. According to the configuration, as long as the optical disc D is not acquired, a specific Advertisement can not be viewed, leading to enhance value of the advertisement.

Still further, it is configured that the download information is recorded on the optical disc D, but it may be possible to acquire it from information sources (the content provider 21 or a recording medium capable of being read out by the disc player 11) other than the optical disc D. With this configuration, even if the optical disc D is a non-rewritable type, the download information can be updated by rewriting information of the information source. Accordingly, it is also possible to rewrite the insertion availability information from “not-available” to “available”. For example, in the above embodiment, though the “TITLE 2” and the “TITLE 3” are recorded with flags as CM insertion information, the advertisement is not inserted because the insertion availability information thereof is “not-available”. By recording flags, it is possible to user when the insertion availability information is rewritten as “available” later.

In the configuration that the download information is acquired from the information source other than the optical disc D, it is preferable that reproduction control information (such as data for analyzing a file structure) necessary for reproducing the main content be recorded in the information source so as to prohibit reproducing the main content only. In other words, it is preferable to construct to prohibit reproducing the main content unless the information source is accessed. Further, in this case, it may be possible either one of the insertion availability information or the address information is acquired from the optical disc D and the other is acquired from the information source other than the optical disc D, rather than both of them.

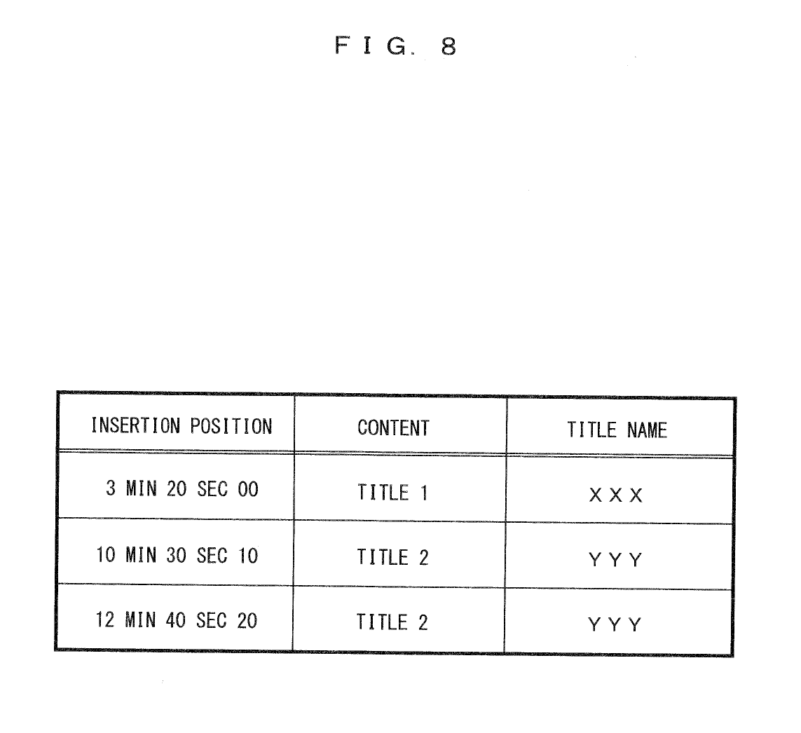

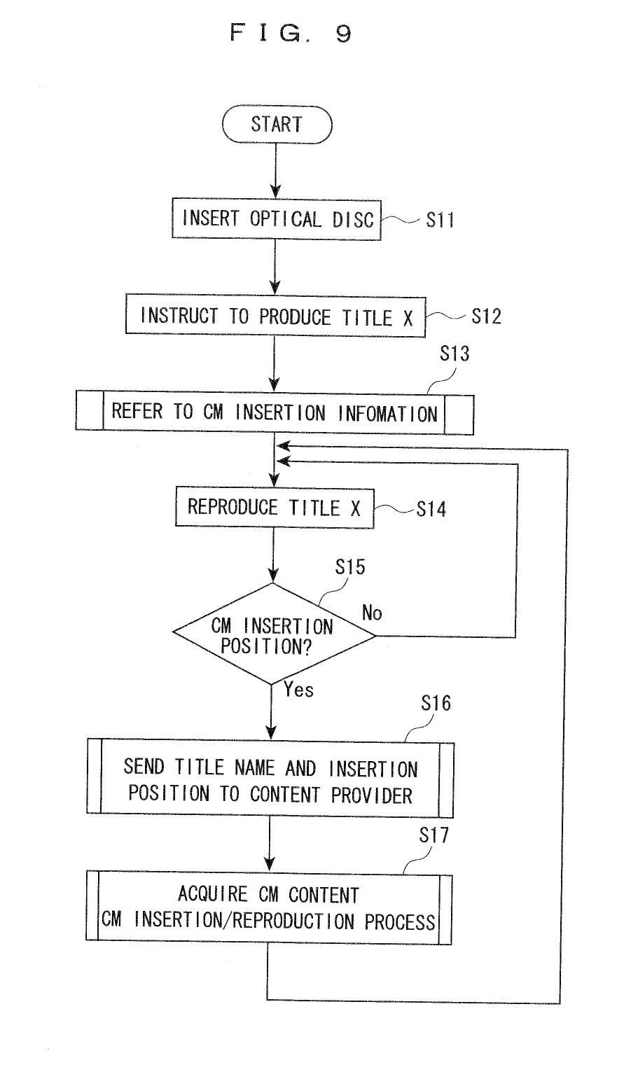

A second embodiment of the invention will be explained with reference to FIGS. 8 and 9. In the first embodiment above, the content provider 21 specifies the advertisement based on the ID sent from the disc player 11. The second embodiment differs from the first embodiment in that the disc player 11 sends information on a title name of the main content and the insertion position, and the content provider 21 specifies (selects) the advertisement based on these pieces of information. The explanation oriented to differences from the first embodiment will be made. A same numeral is numbered for a same structure element of the first embodiment.

As shown in FIG. 8, in the second embodiment, the optical disc D records a table as CM insertion information per record, in which insertion positions are associated with title names of the main contents. The example of FIG. 8 shows that an insertion position “3 min 20 sec 00” is included in the main content of the “TITLE 1” and that a title name thereof is “XXX”. Also, it shows that the insertion positions “10 min 30 sec 10” and “12 min 40 sec 20” are both included in the main content of the “TITLE 2” and that a title name thereof is “YYY”. Therefore, the disc player 11 sends information showing the title name “XXX” and the insertion position “3 min 20 sec 00” to the content provider 21 at timing of reproduction time “3 min 20 sec 00”. Also, the disc player 11 send to the content provider 21 information showing the title name “YYY” and the insertion position “10 min 30 sec 10” at timing of reproduction time “10 min 30 sec 10”, and information showing the title name “YYY” and the insertion position “12 min 40 sec 20” at timing of reproduction time “12 min 40 sec 20”, respectively.

Accordingly, the content provider 21 allows to send the advertisement according to a content of the main content and the reproduction time based on the obtained these pieces of information to the disc player 11. Therefore, the content provider 21 has a database (not shown) in which information showing the title name and the advertisement corresponding thereto is stored and a correspondence table (for example, “Advertisement 1” from the beginning of reproduction to reproduction time XX min XX sec XX, “Advertisement 2” from reproduction time XX min XX sec XX to reproduction time YY min YY sec YY and the like) in which a different Advertisement is associated per predetermined time depending on the title is stored.

In this embodiment, it may be possible to record the insertion position on the main content as a flag and to associate the flag with information showing the title name and the insertion position. Further, especially not described in terms of the download information, it may be possible to configure to acquire the advertisement based on the insertion availability information and address information included in the download information as well as the first embodiment.

AN insertion/reproduction process of the advertisement according to the second embodiment will be explained with reference to a flow chart of FIG. 9. When the optical disc D is inserted (set) into the disc player 11 (S11) and is instructed to reproduce the title X through the operation unit 54 (S12), the controller 55 refers to the CM insertion information (the table shown in FIG. 8) (S13) and the reproducing processor 56 reproduces the title X (S14).

As the controller 55 determines whether the reproduction time reaches at the CM insertion position (S15). If it reaches (S15: Yes), information showing the title name and the insertion position is sent to the content provider 21 (S16).

The content provider 21 acquires these pieces of information (information acquiring means), and specifies the advertisement as insertion object with reference to the above database (Advertisement specifying means). For example, in a case that the main content is discriminated as a content for men from a content name, the advertisement is specified of which object for advertisement is oriented to men. Also, a Advertisement linked to a content of the main content is specified based on the information showing the insertion position. Further, the advertisement specified is sent to the disc player 11 (Advertisement sending means).

When the disc player 11 acquires the advertisement from the content provider 21, the advertisement is inserted into the main content of the title X to be reproduced (S17). Though especially not shown in the flow chart, a return of the flow chart is ended when the title X is reproduced to the end.

Thus, according to the embodiment, it is possible to provide more effective CM to users 15 by sending information showing the title name and the insertion position to the content provider 21 to prompt to specify a Advertisement.

In the embodiment above, the title name is sent, but it may possible to send information for specifying the main content such as an identification code for identifying the main content other than the title name. Further, it may be possible to send a code or the like showing anterior half and posterior half of the main content as information showing the insertion position, rather than the insertion position (reproduction time) itself. It may be also possible to send either one of the information showing the title name only or the information showing the insertion position only, rather than the information showing both the title name and the insertion position.

In the above two embodiment, the CM insertion information and the download information is included in the optical disc, but the download information may not be included or the insertion availability information may not be included in the download information. Further, if it is configured that the ID for specifying the advertisement, the title name and the like is not sent to the content provider 21 (if the CM insertion information is only information showing the insertion position), it is possible to acquire a same Advertisement in at least one main content, leading to impress a content of the CM strongly on users.

Also, in the above two embodiment, the advertisement is acquired during reproducing the main content, but it may be possible to configure to pre-acquire the advertisement before reproducing the main content. In this case, the disc player 11 reads out the CM insertion information and the download information just after the optical disc D is inserted or at the time of acquiring instruction for the advertisement by users 15, and, acquires the advertisement from the content provider 21 based on these pieces of information. Then, the acquired Advertisement is buffered, and the advertisement is read out to be inserted/reproduced at the insertion position included in the CM insertion information. Also in this case, it may be possible to configure that the advertisement is pre-embedded in the main content, and all of the contents to be reproduced are generated to be stored in a predetermined storage area. Further, when the optical disc D is a rewritable disc, the acquired Advertisement may be written on the optical disc D.

The optical disc D is exemplified as a medium recorded with a main content, but other recording media such as a semiconductor memory may be used. Note that it is preferable that the media be a removable type to be easily carried.

Further, it may be possible to provide each structure element (each function) of the content processing system SY and the disc player 11 as a program. Still further, it may be possible to provide the program stored in various recording media (such as a CD-ROM, a flush memory). Accordingly, the program and the recording media storing the programs are also included in a scope of the invention.

It is further understood that various changes and modifications of apparatus structures and process procedures of the disc player 11 may be made other than the preferred embodiments without departing from the spirit and scope thereof.

1-13. (canceled)

14. A content processing apparatus comprising:
a read-out unit which reads out from a recording medium in which a main content and CM insertion information showing an insertion position of an advertisement in the main content as a flag is stored; an advertisement acquiring unit which acquires the advertisement from an external apparatus based on the CM insertion information; and an advertisement insertion unit which inserts the acquired advertisement in the main content; the advertisement acquiring unit acquiring the advertisement with detection of the flag at a time of reproducing the main content.

15. A reproducing apparatus comprising:
a read-out unit which reads out from a recording medium in which a main content and CM insertion information showing an insertion position of an advertisement in the main content as a flag is stored; an advertisement acquiring unit which acquires the advertisement from an external apparatus based on the CM insertion information; an advertisement insertion unit which inserts the acquired advertisement in the main content; and a reproducing unit which reproduces the main content inserted with the advertisement, the advertisement acquiring unit acquiring the advertisement with detection of the flag at a time of reproducing the main content.

16. A reproducing apparatus comprising:
a. read-out unit which reads out from a recording medium in which a main content and CM insertion information showing an insertion position of an advertisement in the main content as a table is stored; an advertisement acquiring unit which acquires the advertisement from an external apparatus based on the CM insertion information; an advertisement insertion unit which inserts the acquired advertisement in the main content; and a reproducing unit which reproduces the main content inserted with the advertisement, the advertisement acquiring unit acquiring the advertisement, by referring to the CM insertion information at a time of reproducing the main content and the reproducing unit reproducing the advertisement at timing based on the insertion position of the advertisement.

17. The reproducing apparatus according to claim 15, wherein the CM insertion information includes an ID for specifying the advertisement, and the advertisement acquiring unit acquires the advertisement specified by the external apparatus by sending the ID to the external apparatus.

18. The reproducing apparatus according to claim 15, wherein the reproducing unit performs a fade-in/fade-out process on the main content before and after the insertion position of the advertisement.

19. The reproducing apparatus according to claim 15, wherein the recording medium is recorded with one or more main contents, each of the main contents is associated with insertion availability information regarding whether the advertisement is inserted or not, and the advertisement acquiring unit acquires the advertisement at the time of reproducing the main content associated with “available” of the insertion availability information.

20. The reproducing apparatus according to claim 19 further comprising a content key acquiring unit which acquires a content key for prohibiting an insertion of the advertisement in the main content, and an insertion availability information rewriting unit which rewrites the insertion availability information of a corresponding main content from “available” to “not-available” with acquisition of the content key.

21. The reproducing apparatus according to claim 19, wherein each of the main contents is associated with address information showing an acquisition source for the advertisement, and the advertisement acquiring unit acquires the advertisement by accessing based on the address information associated with each of the main contents.

22. A content processing system comprising:
a content processing apparatus as set forth in claim 14;
the recording medium; and
the external apparatus.

23. The content processing system according to claim 22, wherein the CM insertion information includes information for specifying the main content and information showing an insertion position of the advertisement, the advertisement acquiring unit acquires the advertisement specified by the external apparatus by sending at least one of the information for specifying the main content and the information showing the insertion position of the advertisement to the external apparatus, the external apparatus comprises a Advertisement storing unit which stores a plurality of Advertisements, an information acquiring unit which acquires at least one of the information for specifying the main content and the information showing the insertion position of the advertisement from the content processing apparatus, a Advertisement specifying unit which specifies the advertisement to be an insertion object from the advertisement storing unit based on the acquired information by the information acquiring unit, and a Advertisement sending unit which sends the specified Advertisement to the content processing apparatus.

24. A recording medium to be recorded with contents in which a plurality of main contents pre-recorded and viewable independently, and CM insertion information in the main content which is information for inserting an advertisement acquired from an external apparatus other than a reproducing apparatus of the recording medium and which shows an insertion position of the advertisement with a flag is stored, the advertisement acquired by the reproducing apparatus with detection of the flag at a time of reproducing the main content.

25. The reproducing apparatus according to claim 16, wherein the CM insertion information includes an ID for specifying the advertisement, and the advertisement acquiring unit acquires the advertisement specified by the external apparatus by sending the ID to the external apparatus.

26. The reproducing apparatus according to claim 16, wherein the reproducing unit performs a fade-in/fade-out process on the main content before and after the insertion position of the advertisement.

27. The reproducing apparatus according to claim 16, wherein the recording medium is recorded with one or more main contents, each of the main contents is associated with insertion availability information regarding whether the advertisement is inserted or not, and the advertisement acquiring unit acquires the advertisement at the time of reproducing the main content associated with “available” of the insertion availability information.
